(19) United States
(12) Patent Application Publication
(10) Pub. No.: US 2010/0106293 A1
(43) Pub. Date: Apr. 29, 2010

(54) POSTAL KIOSK SYSTEM AND METHOD FOR PROVIDING ELECTRONIC POST OFFICE BOX SERVICES

(75) Inventors: Richard W. Heiden, Shelton, CT (US); Ralph A. Rapillo, Trumbull, CT (US)

Correspondence Address: PITNEY BOWES INC., 35 WATERVIEW DRIVE, MSC 26-22, SHELTON, CT, 06484-3000, US

(73) Assignee: Pitney Bowes Inc., Stamford, CT (US)

(21) Appl. No.: 12/256,658

(22) Filed: Oct. 23, 2008

(51) Int. Cl. G06Q 50/00

(52) U.S. Cl. 700/237; 705/1.1

(57) ABSTRACT

A system and method for providing electronic post office box services including a storage system, a retrieval system a postal kiosk and a system processor. The storage system images and stores a plurality of mailpieces and includes a plurality of escort devices disposed in combination with a transport assembly for moving each escort device into and out of a loading station. The retrieval system releases at least one selected mailpiece from the plurality of mailpieces within the storage system and delivers the selected mailpiece to the operator. The postal kiosk includes a display unit and an input device. The display unit displays the imaged mailpiece information associated with selected mailpiece in the storage system and the input device receives an instruction from an operator regarding the selected mailpiece. The system processor communicates the instructions associated with the selected mailpiece from the postal kiosk to the escort devices within the storage system.

### TECHNICAL FIELD

The present invention relates to a system for providing post office box services, and, more particularly, to a new and useful postal kiosk system and method which employs an escort-based storage, conveyance and retrieval system for processing mail.

### BACKGROUND OF THE INVENTION

Post office facilities conventionally offer Post Office (P.O.) boxes to its customers having a need to receive mail at a location other than a home or business. Generally, the post office boxes range in size and cost based upon the perceived need by the customer concerning the number of mailpieces anticipated and the frequency of visits to the postal facility. Postal facilities typically offer these post office boxes on a first-come first-serve basis due to the limited space and number of boxes available. Hence, customers may need to be placed on a list to await the next available P.O. Box.

Inasmuch as each P.O. Box has fixed dimensions and occupies a fixed volume in space, P.O. boxes are not space efficient. Due to a lack of information concerning the number of mailpieces received on any given day or period of days, P.O. Boxes are generally empty for periods of time and almost never completely full. As a result the space utilization is relatively low in comparison to the space occupied by all of the boxes.

The problems associated with the lack of space efficiency are exacerbated at locations where a large number of mail recipients have been temporally co-located such as in military installations/bases. Commonly, military personnel are not afforded the convenience and privacy of a P.O. Box due to the large number of boxes which would be required and the poor utilization of space.

A need, therefore, exists for a system and method for providing post office box services which employs a space efficient loading/storage and retrieval system.

### SUMMARY OF THE INVENTION

A system and method for providing electronic post office box services is disclosed which includes a storage system, a retrieval system, a postal kiosk, and a system processor. The storage system images and stores a plurality of mailpieces and includes a plurality of escort devices disposed in combination with a transport assembly for moving each escort device into and out of a loading station. The retrieval system releases at least one selected mailpiece from the plurality of mailpieces within the storage system and delivers the selected mailpiece to the operator. The postal kiosk includes a display unit and an input device. The display unit displays the imaged mailpiece information associated with the selected mailpiece in the storage system and the input device receives an instruction from an operator regarding the selected mailpiece. The system processor communicates the instructions associated with the selected mailpiece from the postal kiosk to the escort devices within the storage system.

### BRIEF DESCRIPTION OF THE DRAWINGS

The accompanying drawings illustrate presently various embodiments of the invention, and assist in explaining the principles of the invention.

FIG. 1 is a schematic illustration of an electronic post office box system according to the teachings of the present invention including a postal kiosk, a storage system for imaging/loading each mailpiece within an escort device, and a retrieval system for releasing select mailpiece from the storage system and conveying the select mailpieces to an operator.

FIG. 2 is an isolated perspective view of the postal kiosk including a display unit for presenting a visual image of each mailpiece within an electronic post office box, an input device for issuing command signals associated with select mailpieces, and a receptacle for receiving the select mailpieces.

FIG. 3 depicts a partially broken-away schematic side view of an imaging system for scanning/reading mailpiece information from each mailpiece loaded into the storage system and a loading station for loading each mailpiece into a respective escort device.

FIG. 4 depicts a view taken substantially along line 4-4 of FIG. 3 for illustrating an actuation mechanism for opening and closing jaws of the escort device to load and release a mailpiece.

FIG. 5 depicts a view taken substantially along line 5-5 of FIG. 4 for illustrating a cam mechanism for forcibly urging the jaws outwardly to load and release the mailpiece.

FIG. 6 depicts a view taken substantially along line 6-6 of FIG. 1 illustrating a conveyor for delivering released mailpieces to the receptacle of the postal kiosk and a trough for directing released mailpieces to a central portion of the conveyor.

FIG. 7 depicts a bank of postal kiosks for accommodating multiple users/operators at a postal facility.

FIG. 8 depicts another embodiment of the electronic post office box system invention wherein a plurality of personal computers communicates with the system over a communication network.

### DETAILED DESCRIPTION OF AN EMBODIMENT OF THE INVENTION

An electronic post office box system and postal kiosk is described in the context of a mailpiece storage and retrieval system for use in a conventional Post Office facility. While the system has particular utility in a regional/local Post Office, the invention may be implemented at various other locations including corporate offices, commercial facilities, retail establishments, etc. Furthermore, while the invention is most applicable to a conventional Post Office facility, it should be borne in mind that the teachings of the present invention are equally applicable to any processing facility having a large quantity of mail to be stored and retrieved. Furthermore, while the electronic post office box system is described in the context of an escort-based storage/retrieval system employing a plurality of clamps for holding individual mailpieces, the teachings of the present invention are applicable to escort-based systems having any one of variety of holding devices for escorting mail within the storage/retrieval system. In the context used herein, an “escort-based system” is a system wherein individual mailpieces are retained by an escort device and wherein at least a portion of the storage/retrieval operations is conducted by a system which interacts with the escort device rather than with mailpiece itself. In these systems, mailpiece data is captured/stored in a database and an association is made between the mailpiece and a unique identifier on the escort device (discussed and illustrated hereinafter).

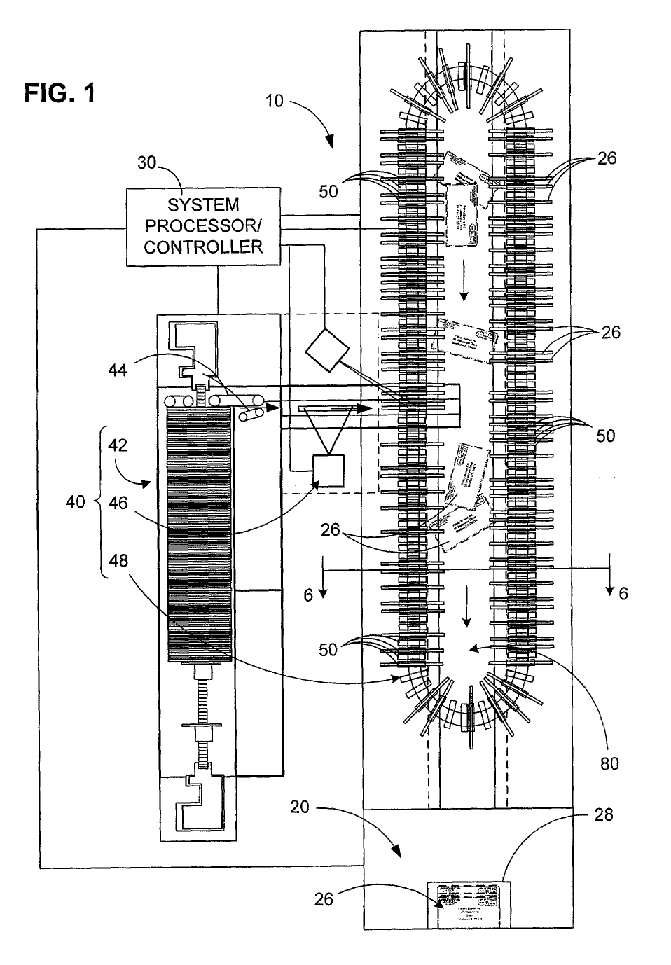

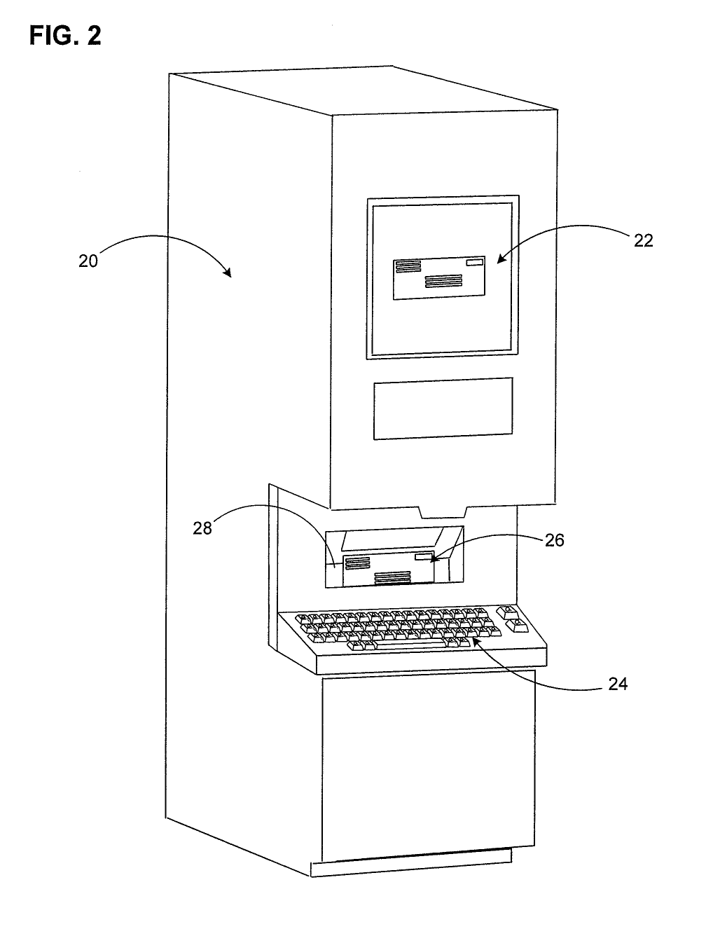

In FIGS. 1 and 2, an electronic post office box system 10 includes a postal kiosk 20, operatively coupled to a storage system 40 and a retrieval system 80. While the interface unit 20, storage system 40 and retrieval system 80 will be discussed in greater detail hereinafter when describing the operation of the system 10, each of the units/systems 20, 40, 80 will be briefly described at this juncture so as to enable a greater understanding of the various functions/features of the electronic post office box 10.

The postal kiosk 20 is operatively coupled to the storage and retrieval systems 40, 80 by means of a system processor 30 which controls the functions of, and integrates, the various systems and subsystems of the electronic post office box system 10. In the described embodiment, a single processor 30 is shown in communication with the various systems/subsystems, though, it should be appreciated that many processors may be substituted therefore, i.e., dedicated to one or more system elements, and, when connected, may be viewed as a single integrated processor 30 such as that shown in the figures.

The postal kiosk 20 includes a visual display unit 22, e.g., a video/liquid crystal display, for displaying mailpiece data associated with at least one selected mailpiece 26 in the storage system 40, an input device 24 operative to receive and issue instructions from an operator regarding the selected mailpiece 26, and, in the described embodiment, a receptacle/container 28 for receiving mailpieces 26 selected by the operator. The receptacle/container 28 may or may not be integrated within the postal kiosk 20, but may simply be located at a convenient location near the interface unit 20 for retrieval of the mail 26 by an operator.

The storage system 40 performs a variety of functions with respect to mail received from various external sources, e.g., collection mail and inbound mail from other distribution/post office facilities. More specifically, the storage system 40 functions to load mail into a plurality of escort devices 50, scan/image mailpiece information/data prior to or immediately following the loading of mail 26 into the escort device 50, store mail 26 for subsequent retrieval, and convey mail 26 along a transport path to pre-position the escort devices 50 for accepting mail 26 into the storage system 40 and to release the selected mailpieces 26 for subsequent retrieval.

The retrieval system 80 functions to receive the selected mailpieces 26 from the storage system 40 and convey the mail 26 to a convenient location for retrieval by an operator/customer. In the described embodiment, the retrieval system 80 issues a wireless signal to a mechanism disposed within each escort device 26 to release the selected mailpiece 26 from the respective escort device 50. Once released, the selected mailpieces are carried to the receptacle/container 28 within the postal kiosk 20.

The features/elements of the electronic post office box system 10 are best understood by describing the logical steps when storing, requesting and retrieving mailpieces 26 in a typical post office facility. In FIGS. 1, 2 and 3 mail 26 is received, either by collection mail or inbound mail from another distribution/sorting center. The mailpieces are then loaded into a conventional feeder 42 which singulates individual mailpieces 26 via a singulating belts 44. The singulated mailpieces 26 are then conveyed along a path which enables mailpiece information 26I, e.g., the destination address and return address, on the face of each mailpiece 26 to be scanned/read by an imaging device 46. In addition to scanning the mailpiece information 26I, the imaging device 46 also scans/reads an identifier 50I, e.g., symbol, on the escort device 50. The system processor 30 then stores and makes an association between the data, i.e., the identifier 50I and the mailpiece information 26, such that the processor 30 maintains an inventory of the location of each mailpiece 26 loaded into the storage system 40. Furthermore, the system processor 30 dynamically assigns/links each escort device 50 with a post office box number/ID.

For example, mailpiece destination information, which will typically include the recipients name and post office box number, can be read by the use of Optical Character Recognition (OCR) software. This information is then associated with the identifier 50I of the escort device 50, i.e., in a database of the processor 30, such that the electronic post office box system 10 can track the escort devices 50, and consequently, the mailpieces 26, associated with a particular electronic post office box number/ID. Furthermore, inasmuch any escort device 50 in the storage system 40 can be dynamically assigned/linked to any electronic post office box number, there is no need to assign a predefined number of escort devices 50 to store mailpieces associated with a particular post office box. As will be discussed in greater detail hereinafter, the ability to dynamically assign/re-assign the use of escort devices is highly efficient in terms of space allocation/resources used.

Each escort device 50 is conveyed along a mechanized transport system 48 and may be opened to accept a mailpiece 26. That is, once an image of the mailpiece 26 has been obtained by the scanner 46, the escort device 50 may be aligned with and opened to accept a mailpiece 26. In the described embodiment, the escort device 50 is suspended downwardly from the transport system 48 and includes a pair of spring-loaded clamps or jaws 56a, 56b. The jaws 56a, 56b are spring-biased to a closed position to secure a mailpiece 26 between the jaws 56a, 56b and may be forcibly opened, i.e., against the spring bias force, by any of a variety of actuation mechanisms/devices. Furthermore, the jaws 56a, 56b may be opened to accept or release a mailpiece (discussed in greater detail below).

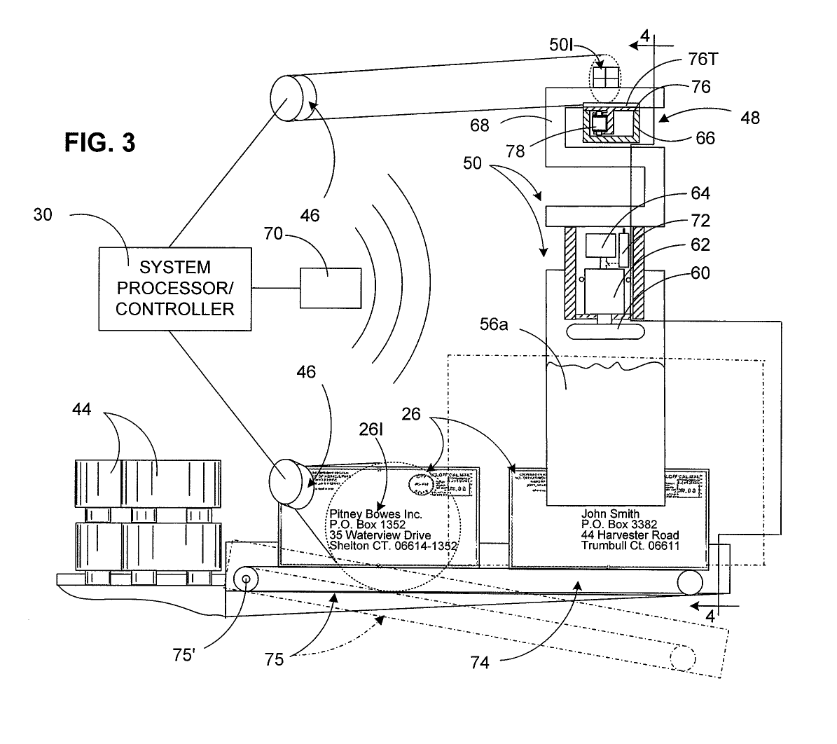

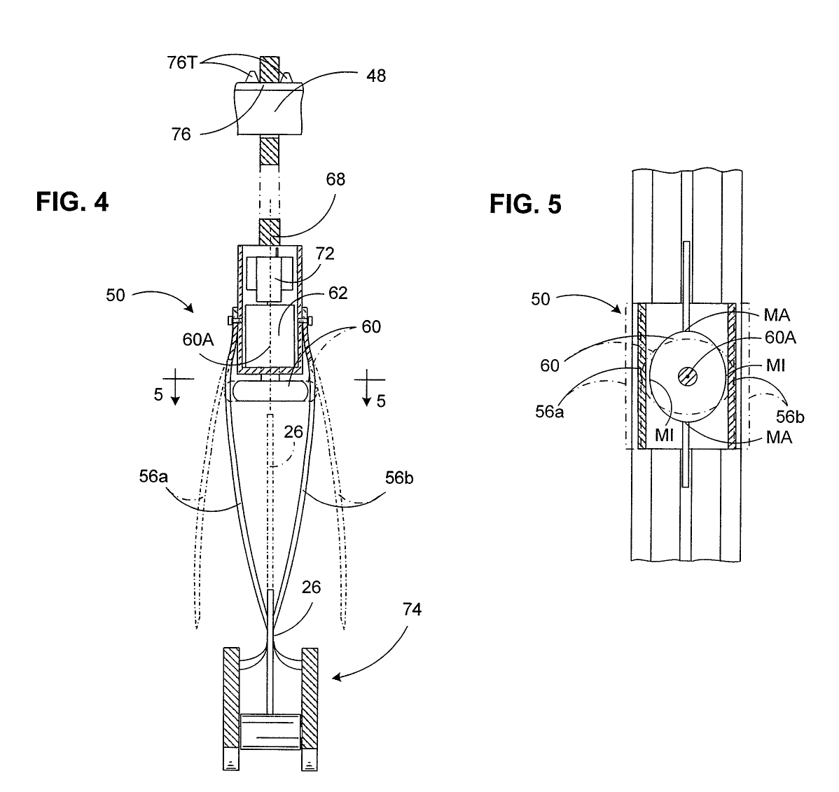

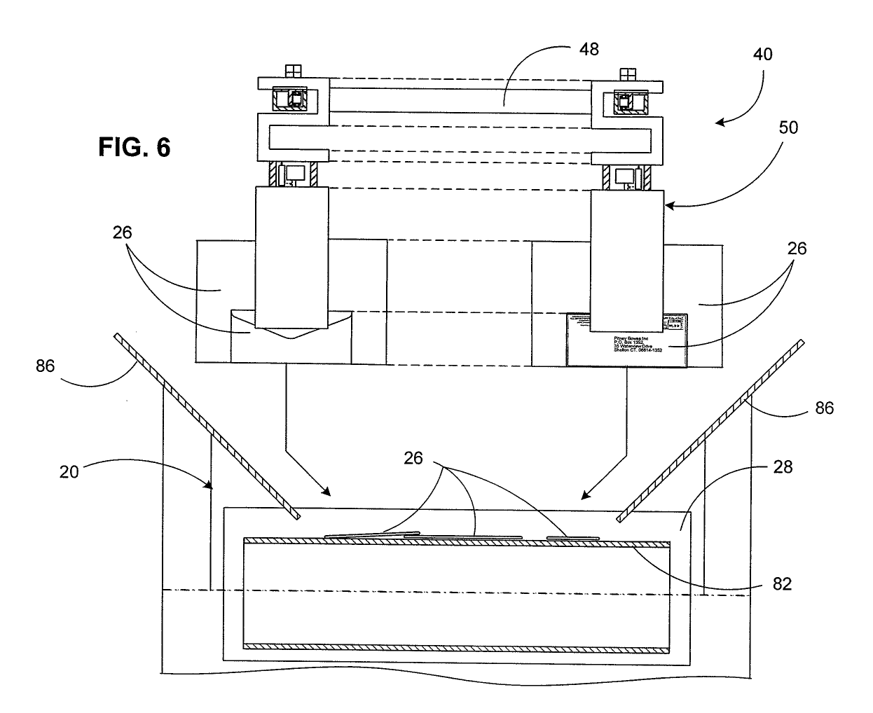

In FIGS. 3, 4 and 5, the escort device 50 includes an elliptical cam 60 which may be rotated about a substantially vertical axis 60A by a rotary actuator mechanism 62. The cam 60 is disposed normal to the axis 60A and is operative to spread the jaws 56a, 56b apart to an open position. That is, by rotating the cam 60 ninety-degrees, cam surfaces MA (see FIG. 5) normal to the major axis of the ellipse urge the jaws 56a, 56b apart (against the spring-biasing force induced by the contour of the jaws 56a, 56b) and by rotating the cam 60 an additional ninety-degrees, cam surfaces MI normal to the minor axis allow the jaws 56a, 56b to relax and return to a closed position. The closed position of the jaws 56a, 56b and cam 60 is depicted in solid lines and the open position is illustrated in phantom.

To facilitate opening and closure of the jaws 56a, 56b, the actuator mechanism 62 may be self-contained and wirelessly activated/controlled. That is, the actuator mechanism 62 may include a rechargeable battery 64 as a source of power, or receive power from one or more charged rails disposed along a support channel 66 of the transport mechanism 48. With respect to the latter, the wire traces (not shown) may be disposed along a surface of an S-shaped hanger 68 which suspends the jaws 56a, 56b from the support channel 66 to electrically connect, and provide power to, the actuator mechanism 62.

In the described embodiment, a Radio Frequency (RF) signal generator 70 is operatively coupled to the system processor 30 to issue command signals to the actuator mechanism 62, to open or close the jaws 56a, 56b of the escort device 50. More specifically, the RF signal generator 70 is capable of issuing multiple frequencies, i.e., one for each escort device 50, within the range or space occupied by the storage system 40. Furthermore, each escort device 50 includes a wireless relay 72 which is tuned, and is responsive, to one of these RF frequencies. To activate each of the escort devices 50, the system processor 30 is pre-programmed to link each wireless relay 72 to a frequency which can be generated by the RF signal generator 70.

Each of the escort devices 50 may be opened or closed for loading and/or release of mailpieces 26. During loading operations, i.e., loading into the storage system 40, a first wireless command signal is issued to the escort device 50 which is pre-positioned to receive a mailpiece 26 from a loading station 74. The wireless relay 72 closes a switch to power the actuator mechanism 62. The actuator mechanism 62 rotates to open the jaws 56a, 56b and a mailpiece 26 is inserted therebetween. Immediately following insertion, a second wireless command signal is issued to rotate the actuator mechanism 62, i.e., an additional ninety-degrees, to close the jaws 56a, 56b onto each face of the mailpiece 26.

The transport mechanism 48 employs a plurality of transport elements 76 which are supported within the support channel 66. In the described embodiment shown in FIG. 1, the support channel 66 is oval in shape to form a continuous elongate loop. Each transport element 76 slides over a sidewall structure of the channel 66 and is driven by a chain drive assembly 78 disposed within the channel 66. Furthermore, each escort device 50 is suspended from one of the transport elements 76 and disposed between transverse teeth 76T thereof such that as the chain assembly 78 moves within the channel, the escort device 50 will follow the transport element 76, i.e., being secured within and driven by the teeth of the transport element 76. A transport mechanism 48 of the type described herein is discussed in greater detail in a co-pending patent application entitled “Escort-based Sorting System for Mail Sorting Centers” Ser. No. ______ which is incorporated herein in its entirety.

After each escort device 50 is loaded, the transport mechanism 48 conveys each mailpiece 26 to a new location, i.e., incrementally moving a loaded escort device 50 away from the loading station 74 and pre-positioning an empty escort device 50 to the loading station 74 to receive a mailpiece 26. This operation may continue until all of the escort devices 50 have been loaded. Furthermore, to the extent that some escort devices 50 may be empty while others, i.e., before and after, may be full, the system processor 30 is operative to track the status and location of every escort device 50 loaded within the transport mechanism 48. As a result, the system processor 30 is operative to move empty escort devices 50 directly to the loading station 74 while allowing other escort devices 50, i.e., those which are full, to move past the loading station 74. With respect to motion during loading operations, it will generally be necessary to lower the loading station assembly 75, e.g., rotation about a pivot 75A (shown in phantom in FIG. 3) to facilitate passage of previously-loaded mailpieces 26.

Thus far in our discussion, mailpieces 26 have been stacked and singulated by the feeder 42, scanned/read by the imaging system 46, and loaded onto the transport mechanism 48 via the loading station 74. Furthermore, the system processor 30 (i) has stored information relating to the escort devices 50, i.e., in a memory storage device, (ii) has correlated the mailpiece information 26I with the respective escort device 50, e.g., within a database of the memory storage device, and (iii) contains specific information pertaining to each escort device 50 (e.g., the activation frequency) which will energize the actuation mechanism 62. The subsequent paragraphs will describe the retrieval system 80 operative to release and convey selected mailpieces 26 to an operator.

The retrieval system 80 is operative to receive selected mailpieces 26 from the storage system 40 and convey the selected mailpieces 26 to a convenient location for retrieval by an operator/customer. In the described embodiment, the retrieval system 80 receives a command signal from the postal kiosk 20 to release selected mailpieces 26 from their respect escort device 50. As mentioned previously, an operator may provide such selection through the input device 24 of the postal kiosk 20. Generally, an operator will input commands relative to an electronic post office box number which have been related to various escort devices 50 within the storage system 40. For, example, the operator may input a post office box number and a personal identification number (PIN) to access data within the electronic post office box system 10. The system 10, or more accurately, the system processor 30 may then present/display visual images of each mailpiece 26 associated with the post office box number on the display unit 22. As each image is displayed, the system 10 may query/prompt the operator regarding whether or not he/she wishes to receive the displayed mailpiece 26. If an affirmative response is provided by the operator, the system processor 30 may set a “retrieve” command/flag in a database to await responses associated with every mailpiece within the electronic post office box. If a negative response is provided, then a “discard” command/flag may be issued by the system processor 30.

Having received various selections from the postal kiosk 20, the system processor 30 commands the retrieval system 80 to retrieve the selected mailpieces 26. In FIG. 6, the retrieval system 80 employs the same RF generator 70, previously used to load mailpieces 26, to unload or release mailpieces from the escort devices 50 within a particular electronic post office box. An RF signal is issued to energize the actuator mechanism 62 within each escort device 50, i.e., associated with the electronic post office box number.

In the described embodiment, the transport mechanism 48 for storing/conveying escort devices 50 and their respective mailpieces 26 may be disposed over a large conveyor 82 which is operative to receive mailpieces 26 released from the escort devices 50 above. Furthermore, the conveyor 82 is operative to transport the selected mailpieces 26 to the receptacle 28 within the postal kiosk 20. Additionally, the conveyor 82 may be driven in two directions to accommodate the retrieval and discard commands of the operator. That is, the conveyor 82 may be driven in one direction to retrieve selected mailpieces 26, and driven in an opposite direction to discard selected mailpieces 26 i.e., to a discard receptacle (not shown).

To ensure that the mailpieces 26 are properly collected, a V-shaped trough 86, which spans the width and length of the transport mechanism 48, may be disposed between the suspended mailpieces 26 above and the conveyor belt 82 below. The V-shaped trough 86 also functions to direct the released mailpieces 26 to a central portion of the conveyor 82.

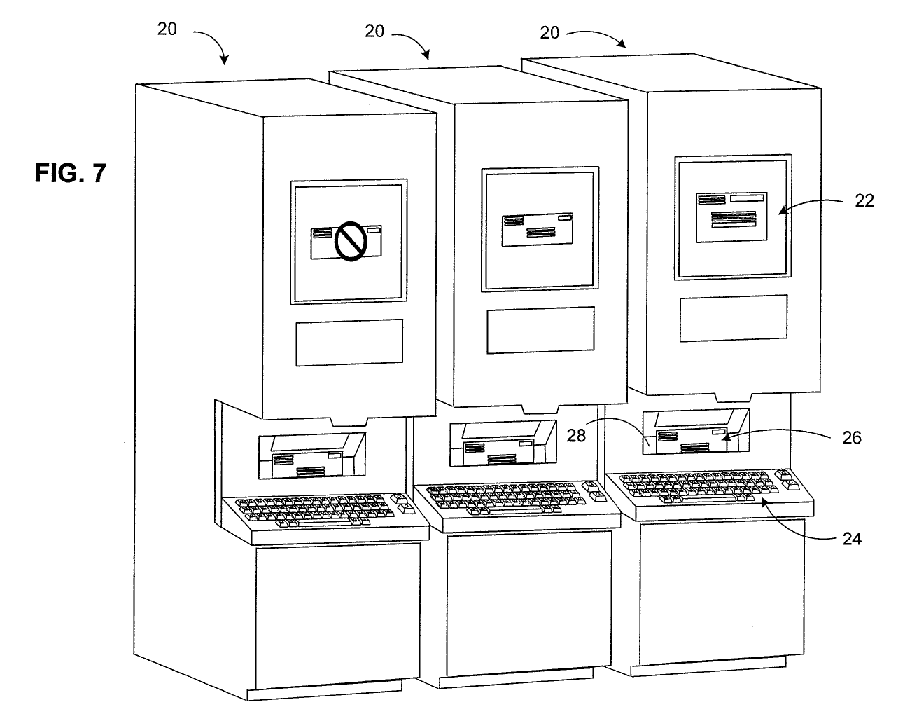

Various modifications, additions and deletions associated with the electronic post office box system 10 may be employed while remaining within the spirit and scope of the present invention. For example, while the system 10 depicts a single postal kiosk 20 disposed in combination with substantially linear storage and retrieval systems 40, 80, it will be appreciated that many variations may be contemplated. In FIG. 7, a bank of three postal kiosks 20 may be employed to accommodate multiple users/operators. These units 20 may be disposed in combination with dedicated storage and retrieval systems 40, 80, or combined to form an integrated system. Of course, several diverting mechanisms e.g. right-angle-turn stations, may be required to feed the selected mailpieces 26 to the receptacle 28 of each postal kiosk 20. While the system 10 of the present invention is depicted as an integrated assembly of various stations/modules, it should be appreciated that the storage and retrieval systems 40, 80 may be expanded or, are scalable, to accommodate additional users/operators. For example, transfer units may be employed to divert mailpieces from one transport mechanism 48 to another, thereby enabling the system to be expanded as needed. Examples of such transfer units and other features which facilitate module expansion are described in co-pending patent application entitled “Escort-based Sorting System for Mail Sorting Centers” Ser. No. ______ filed on ______ 2008.

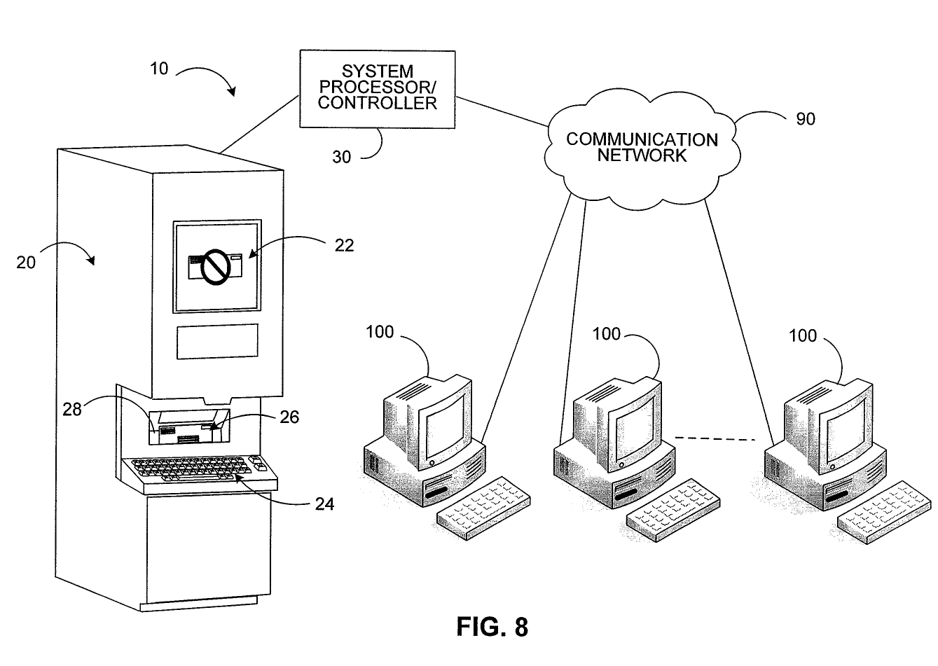

Additionally, various alternate embodiments of the invention are contemplated. For example, in another embodiment and referring to FIG. 8, the electronic post office box system 10 may store the scanned mailpiece information on an electronic server, or over a communication network 90 which is available for access by the operator at a remote location (i.e., via a home computer 100). For example, an operator may access the mailpiece information via an Internet communication network while working from home. Alternatively, the post office box system 10 may send the scanned mailpiece information over a communication network e.g., via electronic mail, to an address specified by the operator. In either scenario, mailpiece information is available to advise the operator of its delivery. As a result, the operator is informed concerning whether or not to visit the postal facility.

Additionally, this arrangement can minimize the time required for an operator to review the selected mailpieces. While the personal computers 100 may be remotely located, i.e., at an operator's home address, it may also be advantageous to include multiple computer stations at the postal facility to more efficiently review the selected mailpieces, i.e., by several operators.

In yet another embodiment of the invention, the operator may input various rules into the electronic post office box system 10 regarding the mailpieces received. For example, an operator may input a rule which provides an electronic notification (via any one of a variety of notification methods including electronic mail, voice mail, text messages etc.) regarding the delivery of a mailpiece requiring a payment, e.g., utility, credit card, loan repayment bills, etc. Similarly, a rule can be input which automatically responds to the delivery of an identifiable mailpiece. For example, an operator may wish to automatically notify solicitors of sporting goods/equipment to remove his/her name from their catalog mailing list.

In summary, the invention provides an electronic post office box system 10 which automates various aspects of mailpiece delivery/retrieval while providing space efficiency. While manual post office box systems of the prior art require a fixed volume of space for each post office box, the electronic post office box system 10 of the present invention provides flexible storage and retrieval systems 40, 80 which communicate with a single postal kiosk 20. Rather than providing a predefined volume of space in anticipation of mailpiece delivery, the system 10 of the present invention allocates space on an, “as needed” basis. That is, the system 10 only assigns an escort device 50 when loading a mailpiece 26. The escort devices are not pre-assigned for use by any one electronic post office box, but are only assigned when a mailpiece associated with a particular post office box is received. While the total number of escort devices 50 will generally be determined at the time of installation/assembly, the ability to dynamically assign the escort devices 50 within the system greatly diminishes the overall space requirements.

It is to be understood that all of the present figures, and the accompanying narrative discussions of preferred embodiments, do not purport to be completely rigorous treatments of the methods and systems under consideration. A person skilled in the art will understand that the elements described represent general cause-and-effect relationships that do not exclude intermediate interactions of various types. A person skilled in the art will further understand that the various structures and mechanisms described in this application can be implemented by a variety of different combinations of hardware and software, methods of escorting and storing individual mailpieces and in various configurations which need not be further elaborated herein.

What is claimed is:

1. A postal kiosk system for providing electronic post office box services, comprising:
a storage system operative to image and store a plurality of mailpieces, the storage system having a plurality of escort devices disposed in combination with a transport assembly for moving each escort device into and out of a loading station, each escort device operative to retain and release a mailpiece;
a retrieval system operative to release at least one selected mailpiece from the plurality of mailpieces within respective escort devices of the storage system, and deliver the at least one selected mailpiece to the operator, and
a postal kiosk operatively coupled to the storage system and having a display unit and an input device, the display unit for displaying imaged mailpiece information associated with at least one selected mailpiece in the storage system, and the input device operative to receive an instruction from an operator regarding the at least one selected mailpiece and issue input command signals indicative thereof, and
a system processor, responsive to the input command signals, operative to communicate the instructions associated with the at least one selected mailpiece from the postal kiosk to the escort devices within the storage system.

2. The postal kiosk system according to claim 1 wherein the system processor is operative to dynamically assign an escort device for receipt of a mailpiece associated with a post office box number, and is operative to communicate an instruction to release the at least one selected mailpiece from the escort device to the retrieval system.

3. The postal kiosk system according to claim 1 wherein the system processor is operatively coupled to a communication network and wherein the mailpiece information may be communicated to the operator over the communication network.

4. The postal kiosk system according to claim 3 wherein system processor issues communications over the communication network based upon a predefined rules provided by the operator.

5. The postal kiosk according to claim 1 wherein the electronic interface is operative to display the at least one selected mailpiece to the operator and receive an instruction from the operator regarding the operator's intention to receive and discard mailpieces from the at least one selected mailpiece.

6. The postal kiosk system according to claim 1 wherein the retrieval system includes a wireless actuation mechanism operative to close the escort device to retain a mailpiece and open the escort device to release the mailpiece.

7. The postal kiosk system according to claim 2 wherein the retrieval system includes a wireless actuation mechanism operative to close the escort device to retain a mailpiece and open the escort device to release the mailpiece.

8. The postal kiosk system according to claim 6 wherein the wireless actuation mechanism is operative to open the escort device for accepting a mailpiece during a loading operation and to close the escort device for retention of the mailpiece.

9. The postal kiosk system according to claim 1 wherein the postal kiosk includes a receptacle operative to receive the at least one selected mailpiece from the retrieval system.

10. The postal kiosk system according to claim 1 wherein the retrieval system includes a bidirectional conveyor, the conveyor moving in one direction to retrieve mailpieces and in another direction to discard mailpieces.

11. A method for providing electronic post office box services comprising the steps of:
providing a postal kiosk having a display unit and an input device, the display unit for displaying imaged mailpiece information associated with at least one selected mailpiece in the storage system, and the input device receiving an instruction from an operator regarding the at least one selected mailpiece;
storing a plurality of mailpieces in an escort-based storage system, the storage system having a plurality of escort devices disposed in combination with a transport assembly for moving each escort device into and out of a loading station;
communicating an instruction via the input device of the postal kiosk to release select mailpieces from the plurality of mailpieces within respective escort devices of the storage system, and
delivering the at least one selected mailpiece from the escort-based storage system to the operator.

12. The method according to claim 11 further comprising the step of dynamically assigning an escort device for receipt of a mailpiece associated with a post office box number.

13. The method according to claim 11 wherein the step of communicating an instruction comprises the step of communicating the instruction over a communication network from a remote location.

14. The method according to claim 11 wherein the step of communicating an instruction comprises the step of providing an instruction to receive and discard mailpieces from the at least one selected mailpiece.

15. The method according to claim 11 wherein the escort device may be wirelessly activated to open and close to release and retain a mailpiece, and further comprising the step of issuing a wireless command signal to the escort device to release the at least one selected mailpiece.

16. A postal kiosk for an electronic post office box system, comprising:
a display unit operative to display select mailpieces within a storage system, the storage system operative to image and store mailpieces within a plurality of escort devices:
an input device operative to receive operator instructions regarding at least one selected mailpiece within the storage system and
a receptacle operative to receive at least one selected mailpiece from the storage system based upon the operator instructions.

17. The postal kiosk according to claim 16 wherein the input device is operative to input operator instructions to retrieve and discard a mailpiece from a plurality of selected mailpieces.
